(19) United States
(12) Patent Application Publication
(10) Pub. No.: US 2011/0196711 A1
(43) Pub. Date: Aug. 11, 2011

(54) Content personalization system and method

(75) Inventors: Larry Vincent Craig, Plymouth, MI (US); Michael T. Burk, Peachtree City, GA (US)

(73) Assignee: Panasonic Automotive Systems Company of America, Division of Panasonic Corporation of North America, Peachtree City, GA (US)

(21) Appl. No.: 12/658,327

(22) Filed: Feb. 5, 2010

(51) Int. Cl. G06Q 30/00; G01C 21/26; G01C 21/00; G06Q 50/00; G06Q 10/00; G06F 3/01; H02J 7/00

(52) U.S. Cl. 705/5; 701/213; 701/300; 715/716; 320/109; 180/65.21; 705/26.7

(57) ABSTRACT

There is provided a system and method of providing personalized content to a user based on the user's interests and the user's geographical location. The method includes receiving media files from a portable device associated with the user and generating a user profile based on the media files. The method also includes receiving a geographical location of the user from a global positioning system (GPS) device. The method also includes receiving content from a service provider based on the user profile and the geographical location. The method also includes providing the content to the user through an infotainment interface included in a vehicle. The content delivered to the user may include media files such as music or audio/visual files that correspond with the user profile. The content may also include messages about events near the user's geographical location that correspond with the user profile.

### FIELD OF THE INVENTION

The present invention generally relates to a content personalization system. More specifically, the present invention relates to a content personalization system that automatically generates a user profile based on media files received from a portable device and delivers personalized content based on the user profile and a location of the user.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Consumers have access to a vast array of products, services, events, and opportunities for social interaction. With such a large marketplace, the challenge of connecting consumers to activities within their area of interest can present challenges. Consumers attempting to find events or services provided in there geographical area may have to search through a large amounts of information, most of which may not be related to the consumer's interests. In some cases, advertising of services and events may be targeted to specific consumers based on geographical location, however, such advertising may not take into account the specific interests of the consumer being solicited. For example, radio and television advertisements are designed to reach a broad audience and may not reflect the personal interests of many listeners.

### SUMMARY OF THE INVENTION

An exemplary embodiment of the present invention provides a method of delivering personalized content to a user through an infotainment interface included in a vehicle. In some embodiments, the method may include receiving media files from a portable device associated with a user and generating a user profile based, at least in part, on the media files. In some embodiments, generating the user profile includes receiving meta-data corresponding to the media files, and adding a user interest indicator corresponding to the meta-data to the user profile. The method may also include receiving a geographical location of the user from a global positioning system (GPS) device. The personalized content may then be received through the infotainment interface from a service provider based, at least in part, on the user profile and the geographical location.

In some embodiments, the content may include additional media files that correspond with the user profile such as music files or an audio/visual files. In such embodiments, the method may include receiving a message from the service provider that identifies the additional media files and sending a purchase request from the infotainment interface to the service provider for the additional media files.

The content may include a message that informs the user regarding an event near the user's geographical location. In such embodiments, the method may include receiving an offer for admission tickets to the event and sending a purchase request from the infotainment interface to the service provider to purchase the admission tickets. The method may also include receiving a confirmation from the service provider confirming a purchase of the admission tickets and receiving an event location that is set as a future destination by a GPS navigation system.

Another exemplary embodiment of the present invention provides a system for providing personalized content. The system may include a content platform configured to receive media files from a portable device and generate a user profile based, at least in part, on the media files. The system may also include a global positioning system (GPS) device communicatively coupled to the content platform and configured to determine a location of the content platform. The content platform may be configured to send the user profile and vehicle location to a service provider via a network and receive content that is identified by the service provider based, at least in part, on the user profile and the vehicle location. In some embodiments, the network may include a power line communications network of an electrical grid.

In some exemplary embodiments, the service provider is configured to provide a personalized access portal accessible through the interne by a Web browser or other Web-based application. The portable device may comprise at least one of a laptop computer, an MP3 player, and an ebook viewer. The content platform may be included in an infotainment interface configured to provide render audio and visual media in a vehicle.

In one exemplary embodiment, the personalized content may include at least one of an audio file and an audio/visual file. In other embodiments, the personalized content may include a message that informs the user regarding an event corresponding with the user profile and the user's geographical location.

An exemplary embodiment of the present invention provides a vehicle that includes an infotainment interface configured to provide audio and visual media in a vehicle and includes a communications interface for receiving media files from a portable device. The vehicle may also include a GPS location device communicatively coupled to the infotainment interface and configured to determine a location of the vehicle. The infotainment interface may be configured to generate a user profile based, at least in part, on the media files stored on the portable device and send the user profile and vehicle location to a service provider via a network and receive content that is identified by the service provider based, at least in part, on the user profile and the vehicle location.

The infotainment interface may include a GPS navigation system and the vehicle location corresponds with an future expected location based on a destination selected by a user through the GPS navigation system. In some exemplary embodiments, the vehicle includes a battery configured to be charged through an electrical grid, and the network comprises a power line communications network accessed through the electrical grid.

According to one exemplary embodiment, the personalized content comprises additional media files that correspond with the user profile. The personalized content may include a message that identifies an event near the vehicle's location corresponding with the user profile. In such embodiments, the infotainment interface may be configured to enable a user to purchase an admission ticket to the event.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a block diagram of a system for providing personalized, location-based content to a user, in accordance with an exemplary embodiment;

FIG. 2 is a process flow chart illustrating a method for providing personalized, location-based content to a user, in accordance with an exemplary embodiment; and

FIG. 3 is a block diagram of a system 300 for enabling user access to personalized, location-based content from a variety of devices, in accordance with an exemplary embodiment.

Corresponding reference characters indicate corresponding parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Exemplary embodiments of the present invention relate to a content personalization system that enables location-based content to be delivered to a user based on the user's interests. The system may automatically generate a user profile based on media files stored by the user on a portable, or nomadic, media device, such as an MP3 player, mobile phone, laptop computer, tablet PC, universal serial bus (USB) flash drive, a digital camera, a personal digital assistant (PDA), and the like. The system may receive a location of the user through a GPS navigation system. Based on the user profile and the user's location, various targeted content may be delivered to the user. For example, in one embodiment a notification may be sent to the user, informing the user of an upcoming event in the user's geographical area that matches the user's interests, for example, a music concert, sporting event, theatrical performance, club meeting, book signing, social event hosted by a local establishment, and the like. The user may also have the option to manually filter these notifications in order to display only certain types of notifications, for example, music concerts or events associated with a specific artist.

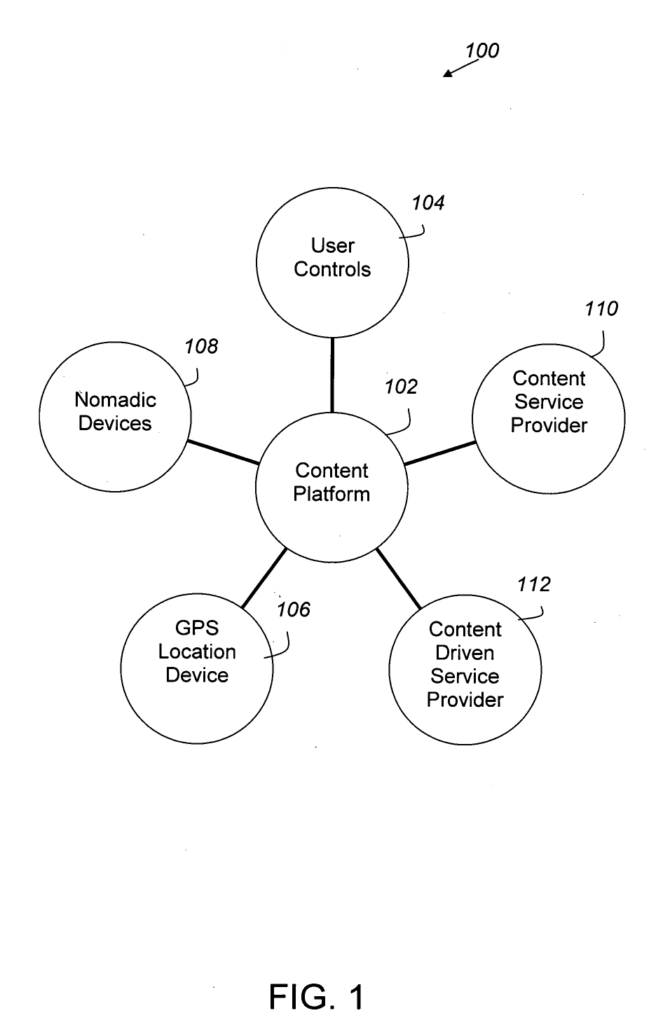

FIG. 1 is a block diagram of a system 100 for providing personalized, location-based content to a user, in accordance with an exemplary embodiment. The system 100 may include a content platform 102 used to access a variety of information and entertainment content. For example, the content platform 102 may include a display screen for rendering visual content and an audio system for playing audio content, either separately from the displayed content or as part of an audio/video program. The content platform 102 may include one or more storage devices to access information such as navigational maps, music CDs, DVDs, or writable CD drives, e.g., for downloading and storing program information. The content platform 102 may also include tangible, machine-readable storage media, such as a storage system for the long-term storage of operating programs and data, including the programs and data used in exemplary embodiments of the present techniques.

In some exemplary embodiments, the content platform may be included in an infotainment interface of a vehicle. As used herein, the term “infotainment interface” refers to an in-vehicle information and entertainment system that combines a fixed user interface with information and entertainment sources located in the vehicle. In such embodiments, the content platform 102 may also include a radio frequency (RF) subsystem that may include AM, FM, and satellite radio systems. Further, the content platform 102 may be coupled to a vehicle audio system, which may include one or more audio speakers distributed throughout the cabin of the vehicle. For the purpose of clarity, embodiments described may be directed to a system 100 wherein the content platform is included in an infotainment interface of a vehicle. However, it will be appreciated that content platform 102 may be included in any suitable mobile or portable device, such as, for example, a laptop computer, mobile phone, personal media player and the like. Such mobile or portable devices are also interchangeably referred to herein as nomadic devices.

The content platform 102 may include a number of user controls 104 for receiving user input. The user controls 104 for the content platform 102 may be built into the display screen, such as controls along the edge of the display screen or the use of a touch screen. Alternately, the user controls 104 for the content platform 102 may be included in a proximate structure, such as a center console, armrest, or steering wheel, to enable ease of access. Through the user controls 104, the user may select specific media files to be displayed or played by the content platform 102. For example, the user may select a specific song, video, text document, map, and the like. The user controls 104 may also enable the user to manage the media files, for example downloading or deleting media files. The user controls 104 may also enable the user to control other systems included in the vehicle, for example, the RF subsystem, vehicle audio system, GPs navigation system, and the like.

The system 100 may also include a GPS location device 106 for determining a location of the content platform 102. The GPS location device 106 may include a RF receiver for receiving GPS satellite transmissions. The location information may be computed by the GPS location device 106 based on the satellite transmissions and communicated to the content platform 102. The display included in the content platform 102 may provide a variety of GPS navigation data, such as maps, current location, route guidance, and the like. The content platform 102 may also enable the selection of various GPS navigation features, for example, trip planning, route guidance, point-of-interest searching, and the like.

In some embodiments, the content platform 102 may be configured to receive and/or view content stored on a nomadic devices 108. As noted above, examples of nomadic devices may include an MP3 player, a mobile phone, laptop computer, tablet PC, a USB flash drive, a digital camera, a personal digital assistant (PDA), and the like. As used herein a nomadic device refers to any handheld electronic device that provides the ability to store electronic files, such as music, pictures, audio/video files, text documents, software applications, and the like. The nomadic devices 108 are capable of being communicatively coupled to the content platform 102 through any suitable electronic communications interface, for example, a local area network (LAN) of the vehicle. The LAN may use any suitable communications protocol, for example, WiFi, Zigbee, Bluetooth, and the like. The electronic communications interface may also include a data port included in the vehicle, for example, a USB port, power line communications (PLC) port, and the like.

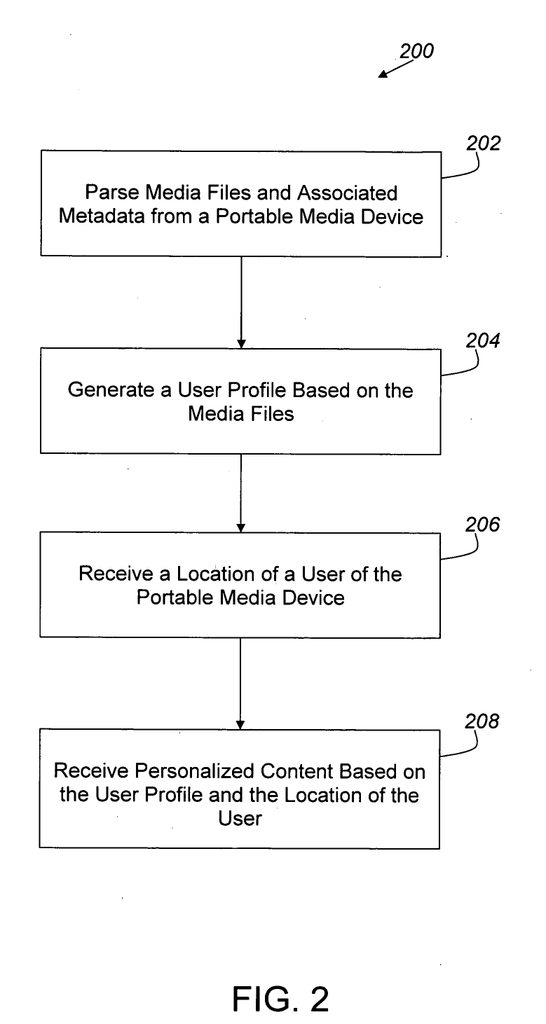

In some exemplary embodiments, the content platform 102 may include hardware or software for generating a user profile that reflects the interests of the user. As discussed further below, in reference to FIG. 2, the user profile may be automatically generated based, in part, on the media files received by the content platform 102 from the nomadic devices 108.

The system 100 may also include a content service provider (CSP) 110 that provides additional media files to the content platform 102, for example additional music files and audio/visual files. The CSP 110 may communicate with the content platform 102 through any suitable network connection, for example, a wide area network (WAN), WiFi network, cellular network, and the like. In the case of an electric vehicle or plug-in hybrid electric vehicle, the CSP 110 may communicate with the content platform 102 through an electrical grid used to charge the vehicle. In such embodiments, the vehicle may include a PLC system for connecting the content platform 102 with service providers through the electrical grid. For example, the vehicle may include an HD-PLC system available from various sources including Panasonic. Corporation. As discussed further below, in reference to FIG. 2, the CSP 110 may receive the user profile from the content platform 102 to identify additional content that may be of interest to the user. The CSP 110 may then provide the content that corresponds with the user profile to the content platform 102. For example, the CSP 110 may provide a list of recommended song titles that the user may select for downloading to the content platform 102.

The system 100 may also include a content driven service provider (CDSP) 112 that provides messages to the content platform 102, informing the user about current or upcoming events in the user's area that may be of interest to the user. The CDSP 112 may communicate with the content platform 102 through any suitable network connection, for example, a wide area network (WAN), WiFi network, cellular network, PLC network, and the like. As discussed further below, in reference to FIG. 2, the CDSP 112 may receive the user profile from the content platform 102 to identify events that may be of interest to the user. The CDSP 112 may also receive location information about the user from the content platform 102. The location information may include the user's current location, which may be determined by the GPS location device 106. The location information may also include an expected future location of the user, which may be determined through a route guidance or trip planning feature of the GPS system included in the content platform 102, for example. The user's location may be used, in addition to the user profile, to identify events of interest to the user that are within the user's current or expected geographical area.

FIG. 2 is a process flow chart illustrating a method 200 for providing personalized, location-based content to a user, in accordance with an exemplary embodiment. In describing certain exemplary embodiments of the method, reference may be made to the system 100 of FIG. 1. However, it will be appreciated that various embodiments described herein may be performed on any suitable system. The method 200 may begin at block 202 wherein the content platform 102 parses the media files and associated file metadata included in a nomadic device such as the nomadic devices 108. The media files may be parsed by the content platform 102 when the nomadic devices 108 is communicatively coupled to the content platform 102. For example, the nomadic devices 108 may be detected by the content platform 102 when the nomadic devices 108 is plugged into a USB port connected to the content platform 102 or the nomadic devices 108 is brought within range of a wireless LAN connected to the content platform 102. Upon detecting the presence of the nomadic devices 108, the content platform 102 may parse some or all of the content from the nomadic devices 108, without prompting from the user.

Parsing the media files and associated file metadata enables the content platform 102 to receive information regarding the user's interests. In some embodiments, the information received by the content platform 102 may relate to media files such as music files, audio/video files, ebooks, and the like. Each of the media files may include file metadata that provides a description of the corresponding file. For example, the file metadata may include information such as song titles, artists, music genre, movie titles, release date, actors appearing in an audio/visual work, movie genre, book title, author, publisher, book topic, and the like.

At block 204, the content platform 102 may automatically generate a user profile based, in part, on the information received by parsing the media files and associated file metadata stored on the nomadic devices 108. The file metadata may be used to identify various content characteristics indicated by the metadata. For each content characteristic identified, an interest identifier may be added to the user profile. For example, the file metadata may indicate that several music files received from the nomadic devices 108 correspond with a particular artist, or music band. In that case, an interest identifier that corresponds with that particular artist or music band may be added to the user profile. In another example, the file metadata may indicate that several music files received from the nomadic device 108 correspond with a particular music genre. In that case, an interest identifier that corresponds with that particular music genre may be added to the user profile. Other types of interest identifiers may be added to the user profile based on any type of information that may be included in the meta-data. Furthermore, the interests identifiers may be ranked according to the prevalence with which certain content characteristics are identified within the content received from the nomadic devices 108. Once generated, the user profile may be updated each time the nomadic devices 108 is coupled to the content platform 102. Furthermore, the user profile may be viewed and manually edited by the user. For example, the content platform 102 may include a user profile interface that allows the user to view the automatically generated user profile and select certain user interest indicators for removal. Furthermore, the user profile interface may include a library of additional user interest indicators that the user may select for adding to the user profile.

The user profile may also include information related to the content platform 102. For example, if the content platform 102 is included in a vehicle, the user profile may include information related to the vehicle, for example, make, model, year, vehicle features, and the like. In another example, if the content platform 102 is included in a mobile device such as a mobile phone, the user profile may include information related to the phone service carrier, phone model, and the like. Such platform related information may be used to deliver platform-specific content to the user, as described below in reference to block 208.

At block 206, a location of the user of the nomadic devices 108 may be obtained. The location may include a current location, as determined by the GPS location device 106. In some embodiments, the location may be a future expected location based on a destination selected by the user through the trip planning or route guidance feature of the GPS system included in the content platform 102, for example.

At block 208, the user profile and location information may be used to deliver personalized content to the user, for example, to the content platform 102. In some embodiments, the user profile and location data may be sent to the CSP 110. The CSP 110 may also receive a list of media files already available to the content platform 102 through the nomadic devices 108. In some embodiments, the user profile may be sent to the CSP 110 each time the user profile is generated or updated. The CSP 110 may then identify additional media files that correspond with one or more of the interest identifiers included in the user profile. For example, the CSP 110 may identify songs or music albums by the same music band identified by one of the interest identifiers. In some embodiments, the CSP 110 may identify media files that also relate to the user's location. For example, the CSP 110 may identify song files for music produced by a local performer that is in a music genre identified by the user profile.

After identifying the media files corresponding with the user profile, the CSP 110 may send a content message to the content platform 102, suggesting one or more media files available to the user for downloading. In some embodiments, the CSP 110 may send content messages to the content platform 102 on a periodic basis, for example, hourly, daily, weekly, and the like. In other embodiments, the CSP 110 may send content messages to the content platform 102 each time the content platform 102 connects to the CSP 110, for example, each time the content platform 102 is activated. The user may then select one or more of the suggested media files to download to the content platform 102 from the CSP 110. For example, the user may send a purchase request from the content platform 102 to the CSP 110 to obtain the media files. The downloaded media files may be stored in the memory device of the content platform 102 or stored on the nomadic devices 108.

In some embodiments, the content platform 102 may receive media from the CSP 110 without prompting from the user. For example, the content platform 102 may be programmed to receive streaming media from the CSP 110. In such embodiments, CSP 110 may add identified media files to a list of media files to be sequentially streamed to the content platform 102.

In some embodiments, the personalized content may include notifications for upcoming events in the user's area that correspond with one or more interest indicators in the user profile. The notifications may be sent to the content platform 102 from the CDSP 112. In some embodiments, the user profile and location data may be sent to the CDSP 112 from the content platform 102. The user profile may be sent to the CDSP 112 each time the user profile is generated or updated. In some embodiments, the current location of the user may be sent to the CDSP 112 when the content platform is activated, for example, when the vehicle is started. The current location may also be sent to the CDSP 112 periodically, for example, while the vehicle is in motion. In some embodiments, the future expected location may be sent to the CDSP 112 when a trip plan or destination is entered by the user into the GPS navigation system of the content platform 102. Using the user profile and location data, the CDSP 112 may identify events near the user's current or expected future location that corresponds with one or more of the interest identifiers included in the user profile. The CDSP 112 may then send a message to the content platform 102 informing the user of the event. For example, if the user profile indicates an interest in a particular musical group, the CDSP 112 may identify an upcoming concert by that group in the user's geographical area, or a sale on music CDs offered by a retailer in the user's geographical area. The CDSP 112 may also enable the user to accept an offer related to the event from the content platform 102, for example, making a reservation, purchasing a product, purchasing admission tickets, and the like. For example, the CDSP 112 may send a message to the content platform 102 that includes an offer for admission tickets to the event. The user may then accept the offer through the content platform 102, in which case the content platform 102 may send a purchase request from the content platform 102 to the CDSP 112 to purchase the admission tickets. In response to the purchase request, the CDSP 112 may send a confirmation to the content platform 102 confirming a purchase of the admission tickets. Furthermore, in some embodiments, the CDSP 112 may also send an event location to the content platform 102, and the event location may be set as a future destination by the GPS navigation system.

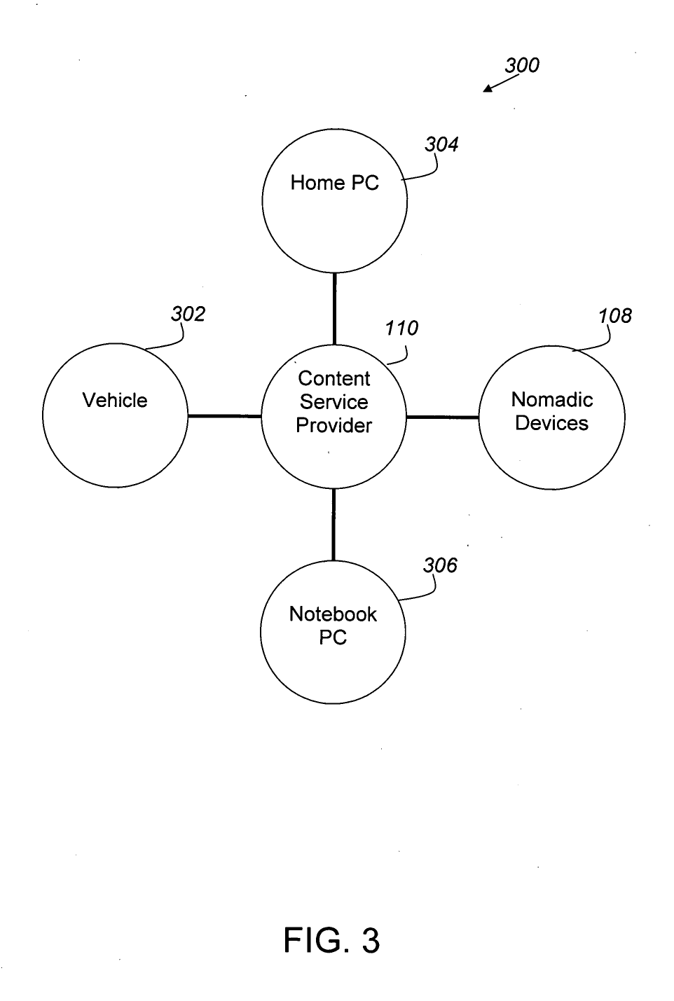

FIG. 3 is a drawing of a system 300 for enabling user access to personalized, location-based content from a variety of devices, in accordance with an exemplary embodiment. As shown in FIG. 3, the system 300 may enable a user to connect to the CSP 110 (FIG. 1) from any suitable electronic device, instead of or in addition to the content platform 102. As noted above, in some embodiments, the content platform 102 may be included in a vehicle 302, for example, a car, a truck, a sport utility vehicle, or a boat, among others. As shown in FIG. 3, the CSP 110 may also be accessible by one or more of a home PC 304, a notebook PC 306, and a nomadic devices 108 (FIG. 1). Thus, the system of FIG. 3 enables the user to access the CSP 110 when the user is away from the vehicle 302.

In some embodiments, the CSP 110 may be accessible to through the Internet. The CSP 110 may provide a portal such as a Webpage that may be accessed by a Web browser of the home PC 304, the notebook PC 306, or the nomadic devices 108. The CSP 110 portal may be personalized for each user that connects to the CSP 110. For example, the CSP 110 may display media files previously downloaded, purchased, or otherwise accessed by the user. The CSP 110 portal may also enable the user to manage a user account. For example, the CSP 110 portal may enable the user to manually edit the user profile. In another example, the CSP 110 may enable the user to purchase additional media files. As discussed above in relation to FIGS. 1 and 2, the CSP 110 may display certain media files that may be of interest to the user, based on the user profile. The user profile may be the user profile generated by the content platform 102 (FIG. 1). Furthermore, the user profile may be updated based on the user's activity performed while visiting the CSP 110 through the other access devices. Furthermore, media files downloaded while accessing the CSP 110 from one of the devices may be available to all of the devices. For example, a user may purchase a group of songs from the CSP 110 while accessing the CSP 110 from the user's home PC 304. The purchased songs may then be downloaded to the content platform 102 of the user's vehicle 302 the next time the user starts the vehicle 302 and the content platform 102 is activated.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of delivering personalized content, comprising:
receiving media files from a portable device associated with a user;
generating a user profile based, at least in part, on the media files;
receiving a geographical location of the user from a global positioning system (GPS) device;
receiving content from a service provider, wherein the content is identified by the service provider based, at least in part, on the user profile and the geographical location; and
providing the content to the user through an infotainment interface included in a vehicle.

2. The method of claim 1, wherein receiving content comprises receiving additional media files that correspond with the user profile.

3. The method of claim 2, wherein the additional media files comprise at least one of a music file and an audio/visual file.

4. The method of claim 2, comprising receiving a message from the service provider that identifies the additional media files and sending a purchase request from the infotainment interface to the service provider for the additional media files.

5. The method of claim 1, wherein receiving personalized content comprises receiving a message that informs the user regarding an event near the user's geographical location.

6. The method of claim 5, comprising receiving an offer for admission tickets to the event and sending a purchase request from the infotainment interface to the service provider to purchase the admission tickets.

7. The method of claim 6, comprising receiving a confirmation from the service provider confirming a purchase of the admission tickets and receiving an event location that is set as a future destination by a GPS navigation system.

8. The method of claim 1, wherein generating the user profile comprises receiving meta-data corresponding to the media files, and adding a user interest indicator corresponding to the meta-data to the user profile.

9. A system for providing personalized content, comprising:
a content platform configured to receive media files from a portable device and generate a user profile based, at least in part, on the media files; and
a GPS device communicatively coupled to the content platform and configured to determine a location of the content platform;
wherein the content platform is configured to send the user profile and vehicle location to a service provider via a network and receive content that is identified by the service provider based, at least in part, on the user profile and the vehicle location.

10. The system of claim 9, wherein the network comprises a power line communications network of an electrical grid.

11. The system of claim 9, wherein the service provider is configured to provide a personalized access portal accessible through the internet by a Web browser or Web-based application.

12. The system of claim 9, wherein the portable device comprises at least one of a laptop computer, an MP3 player, and an ebook viewer.

13. The system of claim 9, wherein the content platform is included in an infotainment interface configured to provide render audio and visual media in a vehicle.

14. The system of claim 9, wherein the personalized content comprises at least one of an audio file and an audio/visual file.

15. The system of claim 9, wherein the personalized content comprises a message that informs the user regarding an event corresponding with the user profile and the user's geographical location.

16. A vehicle, comprising:
an infotainment interface configured to provide audio and visual media in a vehicle, the infotainment interface including a communication interface for receiving media files from a portable device;
a global positioning system (GPS) device communicatively coupled to the infotainment interface and configured to determine a location of the vehicle; and
wherein the infotainment interface is configured to generate a user profile based, at least in part, on the media files stored on the portable device and send the user profile and vehicle location to a service provider via a network and receive content that is identified by the service provider based, at least in part, on the user profile and the vehicle location.

17. The vehicle of claim 16, wherein the infotainment interface comprises a GPS navigation system and the vehicle location corresponds with an future expected location based on a destination selected by a user through the GPS navigation system.

18. The vehicle of claim 16, wherein the vehicle comprises a battery configured to be charged through an electrical grid, and the network comprises a power line communications network accessed through the electrical grid.

19. The vehicle of claim 16, wherein the personalized content comprises additional media files that correspond with the user profile.

20. The vehicle of claim 16, wherein the personalized content comprises a message that identifies an event near the vehicle's location corresponding with the user profile.

21. The vehicle of claim 20, wherein the infotainment interface is configured to enable a user to purchase an admission ticket to the event.
